(19) United States
(12) Patent Application Publication
(10) Pub. No.: US 2007/0137944 A1
(43) Pub. Date: Jun. 21, 2007

(54) Vertical lift assembly

(76) Inventor: Hong Lam, Thornhill (CA)

Correspondence Address: GOWAN INTELLECTUAL PROPERTY, 1075 NORTH SERVICE ROAD WEST, SUITE 203, OAKVILLE, ON, L6M-2G2, CA

(21) Appl. No.: 11/305,100

(22) Filed: Dec. 19, 2005

(51) Int. Cl. B66B 9/02

(52) U.S. Cl. 187/267

(57) ABSTRACT

A vertical lift is provided having a plurality of vertical screws that act to raise or lower a substantially horizontal and flat platform. The vertical screws are operatively linked to a motor by a locked linkage so that the vertical screws are always synchronized, and thereby rotation of the output shaft of the motor results in an equal movement in both vertical screws. Additionally, a vertical lift is provided which is transformable from a straight-through configuration to a corner configuration by simply moving a moveable barrier plate.

### FIELD OF THE INVENTION

The present invention relates generally to the field of vertical lifts, and in particular, to an improved lift mechanism.

### BACKGROUND OF THE INVENTION

Stairways employed in buildings and other structures present difficulties to non-ambulatory individuals. For example, a non-ambulatory individual confined to a personal vehicle such as a wheelchair cannot easily negotiate common stairwells. To accommodate such individuals, separate elevator lifts, moving chair arrangements, or ramps are often provided. In stair structures extending a vertical distance that is less than a building story, such as those typically used near the entrance to a building, a separate elevator lift is not always practical, particularly in outdoor environments. In such cases, separate ramps or moving chair arrangements may be provided which facilitate vertical travel by a personal vehicle.

One drawback to the use of a separate ramp to provide personal vehicle access to elevated surfaces is that suitable ramps consume relatively large amounts of space. As a result, existing buildings must often be substantially altered to accommodate the installation of a ramp. In many circumstances, space constraints within or surrounding the building make installation of a ramp impossible.

Moving chair arrangements offer a solution in such low rise environments. Moving chair arrangements comprise a chair that slides diagonally up and down the stairway. Such arrangements require that the personal vehicle be separately transported up or down the stairway. Because personal vehicles can be quite heavy, separate transport of the personal vehicle can be difficult. Moreover, the movable chair itself, when not in use, still occupies stairway space and thus dictates the appearance of the staircase.

Separate vertical wheelchair lifts, which are termed in the industry as “vertical lifts” have also been employed for such low rise environments for use in situations in which there is inadequate room for an access ramp. Such devices, are commonly used both for interior or exterior applications, and provide the ability to reversibly raise or lower an essentially flat, horizontal platform from a first position to a second position. An example of such a vertical lift is provided in U.S. Pat. No. 5,901,812 issued to Meunier.

Various motive forces can be utilized for raising or lowering the platform including hydraulic lifting systems, pneumatic lifting systems, scissor-jack lifting devices, or the like. However, a particularly common lifting motive force is an electric motor which uses a screw drive connected to a frame that supports the platform. In this type of arrangement, as shown in Meunier, or in Karlsson et al. (U.S. Pat. No. 4,919,236), an electric motor is used to rotate an upright fixed screw which passes through a nut in engagement with the screw, and fixed in the middle of a platform frame. As the screw is rotated by the motor, the nut is forced to move up or down and carries the platform with it.

Several problems can occur with this type of arrangement, namely the entire lifting force of the assembly is concentrated on a single assembly. Should the motor, screw, nut or platform fail, the platform can fall. While using multiple screws might be an option to reduce the load on the single screw, there are operational difficulties in synchronizing two screws to move at exactly the same rate and time so that the platform remains level as it moves up and down.

Additionally, prior art vertical lifts typically are custom manufactured to be used in either a “straight-through” configuration, where the user enters the platform area from one side, and exits the platform area by moving directly through in a straight line, or is used in a corner configuration wherein the user enters from one direction, and turns typically 90 degrees to exit the platform. As a result, both types of units must be stocked.

Additionally, most vertical lift units are manufactured in one location and then shipped to the application site as a single unit. While some components in a simple configuration can be assembled at the site, as shown by Meunier, typically, it is necessary to ship the entire device, as a single unit. As such, it is necessary to know whether a straight-through or corner configuration is desired, and then ship the assembled unit. This is particularly true for an “enclosed” configuration wherein the platform is surrounded on at least three sides, rather than a simpler single side configuration wherein the platform is hung off of the side of a single frame assembly with the remaining sides being open.

As such, there continues to exist a need, therefore, for a improved vertical lift assembly which provides better lifting capability than a single screw configuration, is readily adaptable to be converted from a straight-through configuration to a corner configuration, or the like, on site, and provides an assembly which permits easier shipping and construction of the vertical lift, and in particular, an enclosed vertical lift, at the job site.

### SUMMARY OF THE INVENTION

Accordingly, it is a principal advantage of the present invention to provide a vertical lift assembly that partially or fully meets the goals and objectives set out hereinabove. These advantages, as well as other objects and goals inherent thereto, are at least partially or fully provided by the vertical lift assembly of the present invention, as set out hereinbelow.

In particular, the present invention fulfills the above need, as well as others, by providing a vertical lift assembly which provides a multiple screw arrangement, is manufactured as a series of modular components, and/or provides a flat platform with a modular end plate that can be easily moved from one side to an end in order to provide the ability to convert the enclosed vertical lift from a straight-through configuration to a comer configuration.

Accordingly, in one embodiment, the present invention provides a twin screw vertical lift assembly comprising;

a support structure with a base for housing and supporting said twin screw vertical lift assembly components;

a raisable frame which can be moved between a raised and a lowered position;

an essentially flat horizontal platform resting on said raisable frame;

at least two screw drive systems located within said support structure, each screw drive system comprising a fixed vertical screw in operative engagement with a nut which is operatively fixed to said raisable frame so that rotation of said fixed vertical screw causes said raisable frame to be raised or lowered; and

a motive force for rotation of said vertical screw of said screw drive system,

wherein said motive force is proved by a single motor which motor is operatively connected to all of said fixed vertical screws by a locked linkage assembly.

Preferably, the locked linkage assembly is provided by a toothed belt, a chain and sprocket or a fixed gear arrangement wherein rotational movement of the motor output shaft results in an equal movement of all of the vertical screws. By avoiding the use of non-locked linkage assemblies, such as a plain flat belt, or a simple cross-sectional V-shaped belt, slippage of the screw drive systems, relative to one another, is avoided. As a result, a synchronized movement of the vertical screws is provided.

The number of vertical screws is preferably between 2 and 5, but most preferably, two vertical screws are used in a twin screw configuration.

In a further embodiment of the present invention, a transformable vertical lift assembly is provided which can be easily transformed from a straight-through configuration to a corner configuration. Accordingly, the present invention also provides a transformable vertical lift comprising, a raisable frame, with an attached, essentially horizontal and flat, four sided platform, which frame is operatively connected to a motive force for raising and lowering said frame from a lowered position to a raised position, a support structure for supporting said vertical lift assembly and housing at least part of said motive force, a first side of said platform adjacent to said support structure, a second side opposite to said first side, a moveable enclosure panel which is capable of extending above said platform on either said second side or on a third side adjacent to said second side, and at least two attachment means, one on either said second side or said third side, wherein said movable enclosure panel can be attached to either of said attachment means on said second side or said third side in order to provide either a straight-through configuration or a corner configuration, respectively for passing through said vertical lift.

Preferably, the transformable vertical lift additionally comprises at least one fixed enclosure panel affixed to said frame which fixed enclosure panel extends above said platform on said first side of said platform and is located between said frame and said support structure.

It is noted that this design can use a single screw configuration. However, it is preferred that multiple screw configuration be used that includes at least two vertical screws with the arrangement described hereinabove.

In a further embodiment, the present invention also provides a vertical lift assembly wherein the component parts of the two vertical lift assemblies described hereinabove are provided as a plurality of component pieces which allows the vertical lifts of the present invention to be assembled on site.

### BRIEF DESCRIPTION OF THE DRAWINGS

Embodiments of this invention will now be described by way of example only in association with the accompanying drawings in which:

FIG. 1 is a perspective view of the vertical lift assembly of the present invention, which is shown with twin screw arrangement

FIG. 2 is a side view of the support panel used in the embodiment of FIG. 1;

FIG. 3 is a. cross sectional view of a portion of the support panel in FIG. 2 when viewed from the line designated as 3-3;

FIG. 4 is perspective view of a portion of one of the twin screws;

FIG. 5 is a side view of a portion of one of the twin screws when attached to a raisable frame and platform;

FIG. 6A and 6B are perspective side views of a vertical lift assembly of the present invention wherein a moveable panel is provided; and

FIG. 7 is an exploded view of the vertical lift assembly of FIG. 6 showing its modular construction.

### DETAILED DESCRIPTION OF THE PREFERRED EMBODIMENTS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example only. In the drawings, like reference numerals depict like elements.

It is expressly understood, however, that the drawings are for the purpose of illustration and description only and are not intended as a definition of the limits of the invention.

Also, while a plurality of vertical screws can be used in the practice of the present invention, in a preferred arrangement, two screws are used in the embodiment shown herein in a “twin screw” arrangement. For brevity the remaining discussion will address only a twin screw arrangement, but those skilled in the art will appreciate that more than two vertical screws might also be used.

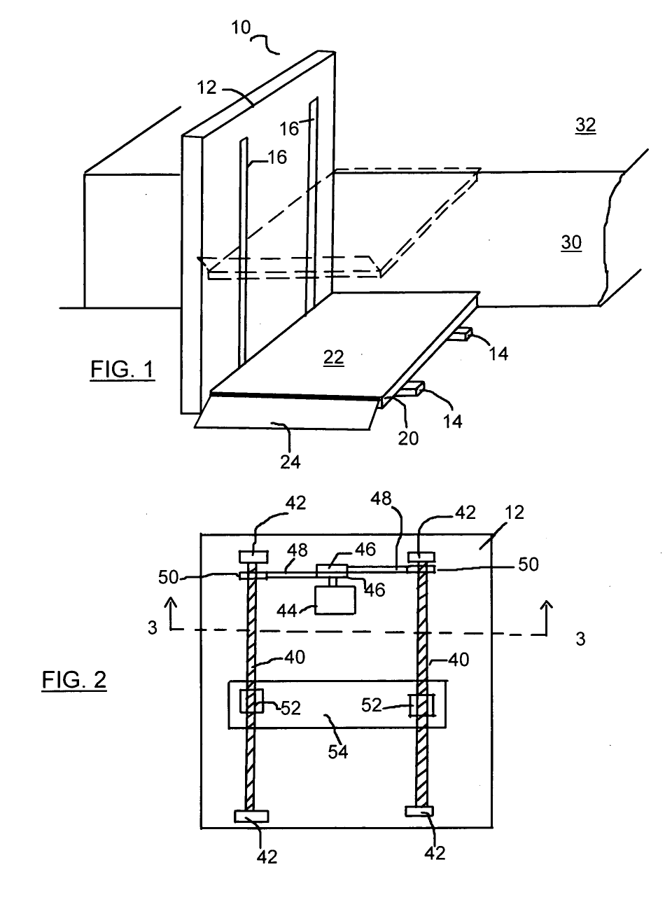

Referring to FIG. 1, a twin screw vertical lift 10 is shown having a support structure 12 resting on two legs 14 which act as a base for lift 10. Support structure 12 has two vertical slots 16 to allow a support arm 18, attached to frame 20 to move. Resting on frame 20 is an essentially horizontal and flat platform 22. At one end of platform 22 is an optional moveable toe plate 24, known in the art, which is moveable from a ramp position when the platform and frame are in a lowered position to a barrier position when the platform and frame are in a raised position, as shown in outline in FIG. 1.

Typically, vertical lift 10 would also comprise a series of barrier plates or railings, but these have been omitted from FIG. 1 to improve the clarity of the figure.

A portion of vertical lift 10, in this embodiment, is positioned against a raised wall section 30 having a floor section 32.

In operation, the user would enter onto platform 22, over ramp 24 when frame 20 was in a lowered position. The vertical lift would be activated to move raisable frame 20 to a raised position (in outline) where the user would exit platform 22 onto floor 32, by traveling straight through vertical lift 10. This is an example of a straight-through configuration. The reverse operation would be conducted to move return back down from floor 32.

In FIG. 2, a rear side view of the interior of support structure 12 is shown having two vertical screws 40 which are fixed into position by assemblies 42 fitted at each end. Screws 40 can rotate, but cannot otherwise move in any direction.

An electric motor 44, as a motive force, is shown fixed to the top of support 12, and having two pulley assemblies 46. Two toothed belts 48 connect pulley assemblies 46 with a corresponding screw pulley 50 on each of the vertical screws 40. Screw pulleys 50 are fixed to vertical screws 40, and they and pulley assemblies 46 all have a toothed configuration which corresponds to the toothed configuration of belt 48 so that rotation of an output shaft from motor 44 results in a specific and equal rotational movement of each of vertical screws 40.

A nut 52 is positioned on each vertical screw 40 having an interior thread which corresponds to the threaded section of vertical screw 40 so that as vertical screw 40 rotates, nut 52 is caused to move earlier upwards or downwards, as is known in vertical screw technology. A face plate 54 is attached to each of nuts 52. While a number of face plates might be used, preferably, a single, common face plate is used and all nuts from all of the vertical screws used, will all connect to the common face plate. This configuration can assist in ensuring that nuts 52 move upwards and downwards at the same rate.

Frame 20 is connected to face plate 54 through support arms 18 so that frame 20 is raised and lowered as face plate 54 is raised or lowered. Support arms 18 are positioned on face plate 54 so that they correspond to, and extend through gaps 16 in the front panel of support structure 12, as is best seen in FIG. 5, which is a end view of a portion of vertical lift 10. Support arms 18 are bolted to face plate 54 and frame 20 using bolts 60.

Electric motor 44 is energized through an electrical control panel (not shown) which is activated by the user wishing to move platform 22 up or down.

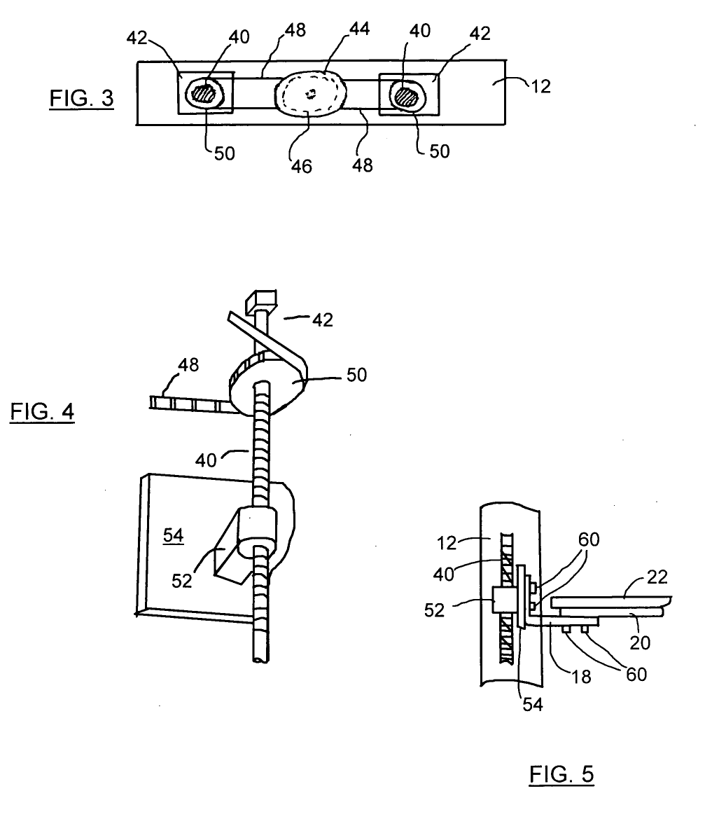

In FIG. 3, a view along the line 3-3 of FIG. 2 is shown showing how motor 44 is operatively connected to each of vertical screws, as previously described.

FIG. 4 provides additional details of the connection of construction of the vertical screw and the operative connection to face plate 54. In particular, the toothed nature of belt 48 is shown together with the corresponding toothed nature of screw pulley 50. Each of pulley assemblies 46 would have a corresponding appearance to screw pulley 50.

It is to be noted that the combination of the toothed belt and the corresponding toothed pulleys provides the locked linkage necessary for the correct operation of the present invention. However, other methods of providing a locked linkage might be used including, for example, a chain and sprocket combination, a direct gear arrangement, or the like.

Additionally, it is to be noted that support arms 18 can be directly connected to nuts 52 without using face plate 54. Other methods for connecting frame 20 to nuts 52 might also be used.

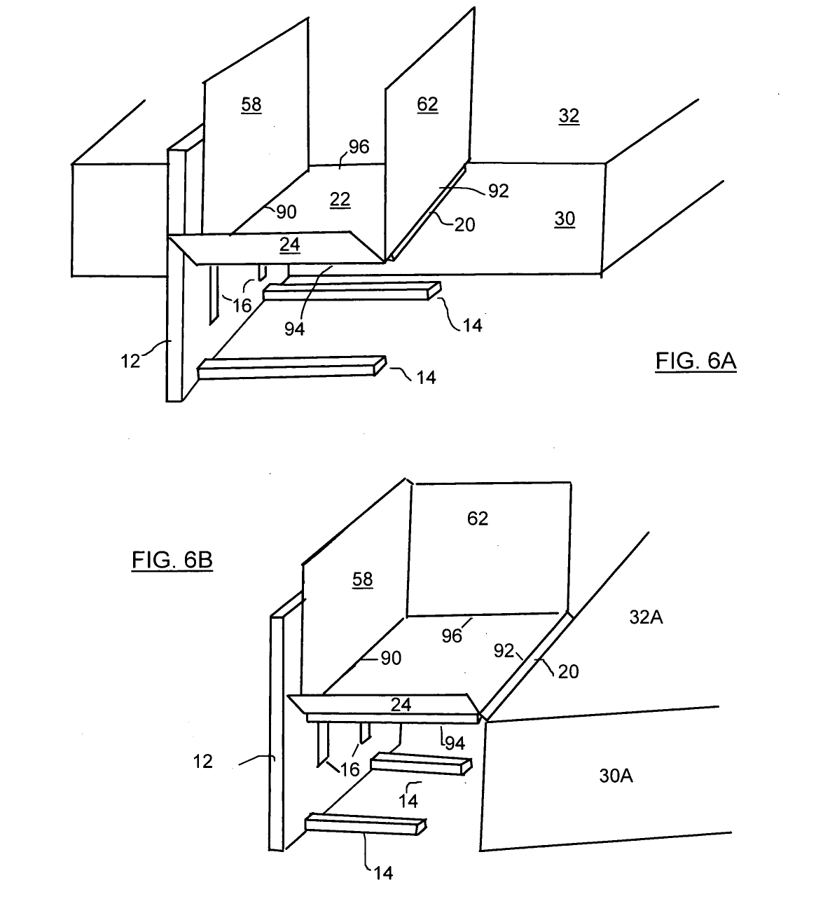

In FIG. 6A, the frame 20 and platform 22 sections of lift 10 are shown, in a raised configuration, wherein a barrier plate 58 has been added. Frame 20 has two sides, namely sides 90 and 92, and two ends, namely ends 94 and 96. Barrier plate 58 is bolted to frame 20 and is fitted to the vertical lift so that it is located on side 90 between platform 22 and support structure 12. This prevents the user from inadvertently getting caught between frame 20 and support structure 12 as frame 12 is moving up or down.

In the straight-through configuration described with respect to FIG. 6A, a second, moveable barrier plate 62 is shown on the opposite side of platform 22, namely side 92. As such, the user can enter from one end 94 of platform 22 and passes directly through the platform to exit from opposite end 96.

Moveable barrier plate 62 is connected to side 92 of frame 20 by using an attachment system that is easily attached on site so that moveable barrier plate 62 can be attached to frame 20 in the straight-through configuration. The attachment system is preferably achieved by using a series of bolts wherein moveable barrier plate 62 is provided with a series of holes through which the bolt may pass, and side 92 of frame 20 has a series of bolt holes adapted to receive the threaded end of the bolt. However, other systems for attaching moveable barrier plate 62 to the side 92 of frame 20 might also be used.

In this embodiment of the invention, however, the end (or otherwise termed an adjacent side) 96 of frame 20 has exactly the same moveable barrier attachment system as side 92. As such, on site, the user can decide whether to attach moveable barrier plate 62 to either of side 92 or end 94 of frame 20. When attached to end 96, as shown in FIG. 6A, the user enters onto platform 22 from end 94 and exits the platform 22 onto the floor 32A, on wall 30A, by exiting off of side 92. This provides a corner configuration, as previously described.

With this arrangement, the user has the option of installing the same vertical lift in either a straight-through, or a comer configuration. The manufacturer need only to stock or supply one model, and the user and/or installer can determine the final configuration of the vertical lift depending on their particular application.

This option exists regardless of whether a single screw vertical lift or a multiple screw vertical lift is used. Preferably, however, the vertical lift has a twin screw arrangement as shown in FIGS. 6A and 6B. Also, while a solid barrier plate is shown, the barrier plate might be non-solid, and thus can be, for example, a wire mesh, a screen, a railing system, or the like.

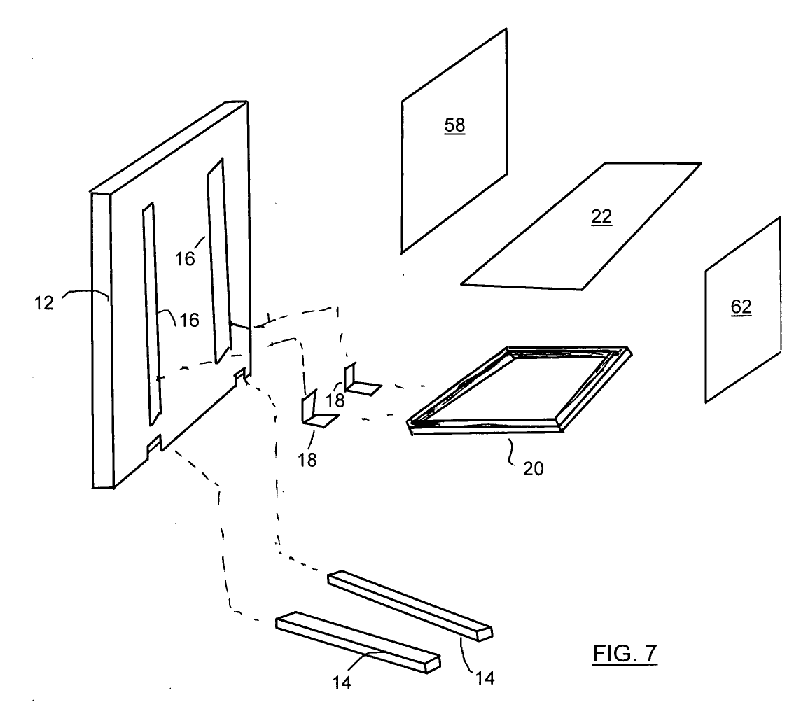

A further feature of the present invention is that the components of the vertical lift are easily assembled on site. As such, the components can be individually shipped or replaced, as necessary by replacement or shipping of a specific module. This modular construction is depicted in FIG. 7 by showing an exploded view of the components of the vertical lift of FIG. 6A. To construct the vertical lift of FIG. 6A, legs 14 are bolted to support structure 12, support arms 18 are bolted to face plate 54 through gaps 16, frame 20 is bolted to support arms 18, barrier plate 58 is bolted to frame 20, platform 22 is bolted to frame 20, and toe plate 24, with its moving linkages (not shown) is attached to frame 20. Finally, moveable barrier plate 62 is fitted to frame 20 to provide either a straight-through configuration or a comer configuration, as previously described.

Accordingly, in a further embodiment, a modular configuration of a vertical lift is provided.

Still further, in an additional aspect, the present invention also provides an improved method for lifting a person or an object, such as a wheelchair or other personal vehicle, from a lower surface to an upper surface, using the devices of the present invention, as hereinabove described.

Thus, it is apparent that there has been provided, in accordance with the present invention, a vertical lift assembly which fully satisfies the goals, objects, and advantages set forth hereinbefore. Therefore, having described specific embodiments of the present invention, it will be understood that alternatives, modifications and variations thereof may be suggested to those skilled in the art, and that it is intended that the present specification embrace all such alternatives, modifications and variations as fall within the scope of the appended claims.

Additionally, for clarity and unless otherwise stated, the word “comprise” and variations of the word such as “comprising” and “comprises”, when used in the description and claims of the present specification, is not intended to exclude other additives, components, integers or steps.

Moreover, the words “substantially” or “essentially”, when used with an adjective or adverb is intended to enhance the scope of the particular characteristic; e.g., “substantially planar”, or “essentially planar” is intended to mean planar, nearly planar and/or exhibiting characteristics associated with a planar element.

Also, while this discussion has addressed prior art known to the inventor, it is not an admission that all art discussed is citable against the present application.

We claim:

1. A multiple screw, vertical lift comprising;
a support structure with a base for housing and supporting said multiple screw vertical lift assembly components;
a raisable frame which can be moved between a raised and a lowered position;
an essentially flat horizontal platform resting on said raisable frame;
at least two screw drive systems located within said support structure, each screw drive system comprising a fixed vertical screw in operative engagement with a nut which nut is operatively fixed to said raisable frame so that rotation of said fixed vertical screw causes said raisable frame to be raised or lowered; and
a motive force for rotation of said vertical screw of said screw drive system,
wherein said motive force is proved by a single motor which motor is operatively connected to all of said fixed vertical screws by a locked linkage assembly.

2. A multiple screw, vertical lift as claimed in claim 1 comprising between 2 and 5 vertical screws.

3. A multiple screw, vertical lift as claimed in claim 2 comprising 2 vertical screws.

4. A multiple screw vertical lift assembly as claimed in claim 1 wherein said locked linkage assembly is provided by a toothed belt, a chain and sprocket or a fixed gear arrangement.

5. A multiple screw vertical lift assembly as claimed in 4 wherein said locked linkage assembly results in a synchronized movement of all of the vertical screws, so that rotational movement of the motor output shaft results in an equal movement of all of the vertical screws.

6. A multiple screw vertical lift as claimed in claim 1 wherein said lift is constructed of a number of modular components so that said multiple screw vertical lift is shipped as a plurality of component pieces so that said multiple screw vertical lift can be assembled on site.

7. A multiple screw vertical lift as claimed in claim 1 wherein each nut for each vertical screw is operatively connected to said frame using a support arm.

8. A multiple screw vertical lift as claimed in claim 1 wherein each nut of each vertical screw is connected to a face plate, and said face plate is connected to said frame using a support arm.

9. A multiple screw vertical lift as claimed in claim 8 wherein each nut of each vertical screw is connected to the same face plate.

10. A transformable vertical lift comprising, a raisable frame, with an attached, essentially horizontal and flat, four sided platform, which frame is operatively connected to a motive force for raising and lowering said frame from a lowered position to a raised position, a support structure for supporting said vertical lift assembly and housing at least part of said motive force, a first side of said platform adjacent to said support structure, a second side opposite to said first side, a moveable enclosure panel which is capable of extending above said platform on either said second side or on a third side adjacent to said second side, and at least two attachment means, one on either said second side or said third side, wherein said movable enclosure panel can be attached to either of said attachment means on said second side or said third side in order to provide either a straight-through configuration or a comer configuration, respectively for passing through said vertical lift.

11. A transformable vertical lift as claimed in claim 10 additionally comprising at least one fixed enclosure panel affixed to said frame which fixed enclosure panel extends above said platform on said first side of said platform and is located between said frame and said support structure.

12. A transformable vertical lift as claimed in claim 10 wherein said vertical lift comprises at least two vertical screws for raising or lowering said frame.

13. A transformable vertical lift as claimed in claim 10 wherein said lift is constructed of a number of modular components so that said transformable vertical lift is shipped as a plurality of component pieces so that said transformable vertical lift can be assembled on site.
